(19) United States
(12) Patent Application Publication
(10) Pub. No.: US 2015/0149170 A1
(43) Pub. Date: May 28, 2015

(54) NOTE PROMPT SYSTEM AND METHOD USED FOR INTELLIGENT GLASSES

(71) Applicants: INVENTEC (PUDONG) TECHNOLOGY CORPORATION, Shanghai (CN); INVENTEC CORPORATION, Taipei (TW)

(72) Inventor: Yi-hong ZHONG, Shanghai (CN)

(73) Assignees: INVENTEC (PUDONG) TECHNOLOGY CORPORATION, Shanghai (CN); INVENTEC CORPORATION, Taipei (TW)

(21) Appl. No.: 14/248,436

(22) Filed: Apr. 9, 2014

(30) Foreign Application Priority Data
Nov. 27, 2013 (CN) 201310637674.8

(51) Int. Cl. G06F 17/21; G10L 15/26; G06F 3/16

(52) U.S. Cl. CPC G06F 17/211; G06F 3/167; G10L 15/26
USPC 704/235; 715/273

(57) ABSTRACT

A note prompt system and method used for intelligent glasses are disclosed, where the text content are detected and a reading information comprising the original content and note is acquired. When the original content includes the original content, the associated note is directed to be displayed on the glasses of the intelligent glasses, whereby achieving in the technical efficacy of promoting convenience of note prompt.

### BACKGROUND OF THE RELATED ART

1. Technical Field

The present invention relates to a system and method, and particularly to a note prompt system and method used for intelligent glasses, where the intelligent glasses are used to display the note.

2. Related Art

Recently, with rapid development of technology, keeping note has become a tiresome and time consuming job, particularly when learning materials are too much, learners cannot organize various notes or find notes rapidly.

Generally, the note organization typically comprises classification, summary and so on. However, its waste time and it has still to use a uniform organization method for the note generated from the digital and traditional learning at the same time. Shortly, it is so inconvenience to organize notes.

In view of the above, it may be known that there has long been the inconvenience issue of note organization. Therefore, there is quite a need to set forth an improvement means to settle down this issue.

### SUMMARY

The present invention discloses a note prompt system and method used for intelligent glasses.

According to the present invention, the note prompt system used for intelligent glasses comprises an acquiring module, acquiring at least a reading information, comprising an original content and a note, the note being associated with the original content; a detecting module, detecting a text content; and a displaying module, displaying the note on the glasses of the intelligent glasses when detecting the original content in the text content.

The note prompt method used for intelligent glasses, comprises steps of acquiring at least a reading information by the intelligent glasses, the reading information comprises an original content and a note, the note being associated with the original content; detecting text content by the intelligent glasses; detecting the original content in the text content; and displaying the note on the intelligent glasses.

The system and method of the present invention has the difference as compared to the prior art that the text content are detected and a reading information comprising the original content and note is acquired. When the text content includes the original content, the associated note is directed to be displayed on the glasses of the intelligent glasses.

By using the above technical means, the technical efficacy of promoting convenience of note prompt may be achieved.

### BRIEF DESCRIPTION OF THE DRAWINGS

The present invention will be apparent from the following detailed description, which proceeds with reference to the accompanying drawings, wherein the same references relate to the same elements.

FIG. 1 is a systematic block diagram of a note prompt system according to the present invention;

FIG. 2 is a flowchart of a note prompt method according to the present invention;

FIG. 3 is a schematic diagram of acquiring a reading information according to the present invention;

FIG. 4 is a schematic diagram of detecting text content according to the present invention; and

FIG. 5 is a schematic diagram of displaying a note according to the present invention.

### DETAILED DESCRIPTION

The present invention will be apparent from the following detailed description, which proceeds with reference to the accompanying drawings, wherein the same references relate to the same elements. With reference to the detailed description, those skilled in the art may use the technical skill to solve the associated problem and thus achieve in the technical efficacy associated therewith, namely, may be enabled to implement the present invention.

Prior to the description of a note prompt system and method used for intelligent glasses according to the present invention, some privately defined nouns in this invention will be first explained. In this invention, the reading information comprising an original content and its associated note. For example, the original content “apple” and its associated note “edible fruit”, the two are jointly named as “reading information”. As to the text content, it refers to the text detected by the intelligent glasses by the user, such as a whole article and article paragraphs.

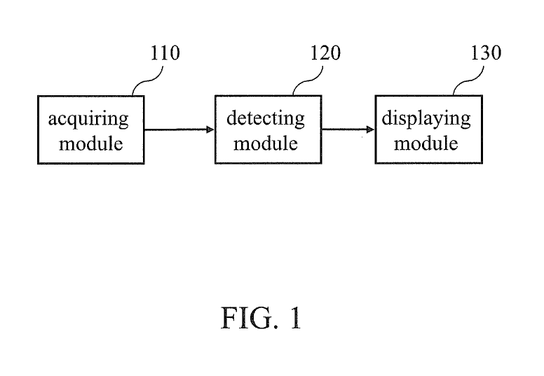

In the following, the note prompt system and method used for intelligent glasses according to the present invention will be described in more details with reference to the figures. Referring to FIG. 1, a systematic block diagram of a note prompt system according to the present invention is shown. The system comprises an acquiring module 110, a detecting module 120 and a displaying module 130.

The acquiring module 110 is used to acquire the reading information, in which the reading information comprises the original content and note. For example, a user marks up “apple” on a book, and writes texts “edible fruit” ,the “edible fruit” is associated with the “apple”, then the acquiring module 110 takes the text “apple” as the original content, and takes “edible fruit” as the note. And, the note being associated with the original content, the original content and the note are jointed as the reading information.

In other situations, the reading information comes from materials that organized by the user and the note written by the user. The reading information may also be stored in a storage element of the intelligent glasses or on a cloud end, so that the associated note may be displayed when the original content is in the text content next time. Since the definition of the reading information has been given above, it is omitted herein.

In addition, the acquisition of the reading information may be achieved by photographing or scanning, or even by using a sound receiving element. When using the sound receiving element, generating the original content and note by using a speech-to-text (STT) technology. In many cases, when the sound receiving element received the sound, and the sound is conversed into a text by the speech-to-text (STT), the user determine which part is the original content and note, for example, the user speak out an article and a explanation of the article, the article is determined as the original content and the explanation s determined as the note.

The detecting module 120 is used to detect the text content, which may similarly be achieved by photographing or scanning like that in the case of acquisition of the reading information. In real implementation, a photographing element may be disposed on the intelligent glasses to take an image of the texts, and a text recognition technology is used to convert the texts in the image into letters and words. Apart from this, a text scanning technology can be also used to scanning the text and convert the texts into letters and words. Since the text recognition technology and text scanning technology are both conventional, and thus omitted herein for clarity.

The displaying module 130 is used to display the note on the glass of the intelligent glasses when detecting the original content is in the text content. In real implementation, the displaying module 130 compares the text content and the original content. When the original content exists within the text content, the associated note is displayed on the glass of the intelligent glasses. For example, assume the text content is “apple on the tree”, the original content is “apple” and the associated note is “edible fruit”.

After the comparison, the displaying module 130 finds that the original content “apple” exists within the text content “apple on the tree”, it displays the note “edible fruit” associated with the original content “apple” on the glass of the intelligent glasses. It is to be particularly pointed out that the displaying module 130 may also, in real implementation, project the note on the text content by using a projection. Namely, when the text content is on a sheet, the intelligent glasses may project the note around the text content on the sheet for displaying the note.

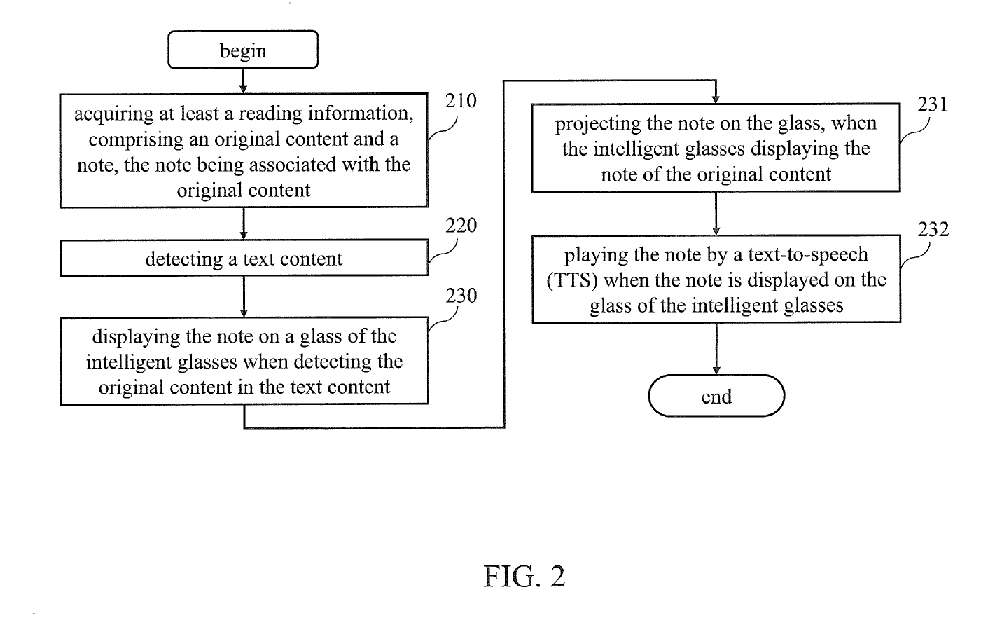

Thereafter, referring to FIG. 2, a flowchart of a note prompt method according to the present invention is shown therein. The method comprises the following steps. First, the intelligent glasses acquire a reading information, which comprises an original content and a note (Step 210). Then, a text content is detected (Step 220). When the original content is detected as appearing in the text content, the intelligent glasses display the note on the glass of the intelligent glasses (Step 230). By means of the above steps, the text content is detected and the reading information is acquired. Since the reading information comprises the original content and the note, the note associated with the original content is displayed on the glass of the intelligent glasses when the original content appears in the text content.

It is to be particularly pointed out that when the note is displayed on the glass of the intelligent glasses in step 230, the intelligent glasses may project the note on the glass (Step 231), and further play the note by a text-to-speech (TTS) technology. Since the TTS technology is conventional, and thus omitted herein for clarity.

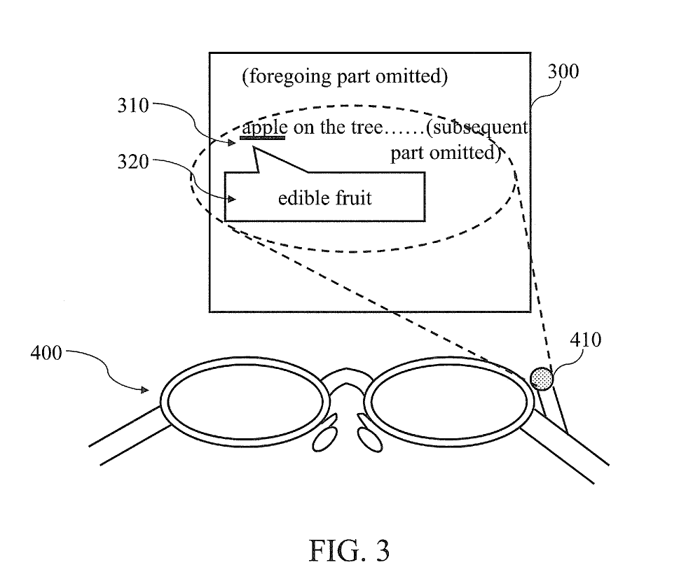

In the following, from FIG. 3 to FIG. 5 are explained in an embodiment form. At first, referring to FIG. 3, which is a schematic diagram of applying the acquisition of the reading information according to the present invention.

In real implementation, the acquisition of the reading information by the intelligent glasses may be achieved through a photographing element 410, the photographing element 410 acquire the reading information from a document 300 which is already has some notes. For example, text which is marked up 310 can be detected as the original content, and the note 320 is detected as the note. It may be particularly indicated that the recognition of the original content and note in the process of acquiring the reading information can use a specified color or indication.

For example, the text which is underlined in red is taken as the original content and the text which is in a circle or square is taken as the note.

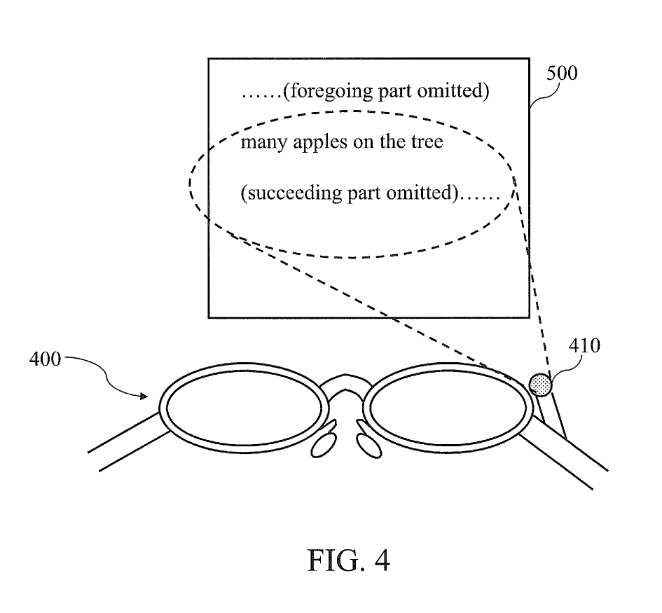

FIG. 4 is a schematic diagram of applying the detection of the text content according to the present invention. Assume the intelligent glasses 400 have acquired many reading information by using the photographing element 410 previously. When the user browses to another document 500 by wearing the intelligent glasses, the detecting module 120 will detect the text content of the document 500 through the photographing element 410, such as “. . . (omitted) some apples on the tree (omitted) . . . ”. In real implementation, the intelligent glasses 400 may acquire the text content of the document 500 by using the text recognition technology.

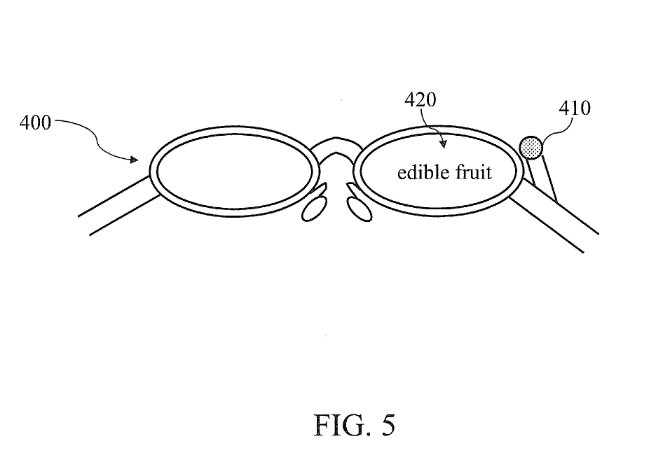

FIG. 5 is a schematic diagram of applying the display of the note according to the present invention. When the intelligent glasses 400 detects text content, the displaying module 130 may display the note associated with the original content on the glass 420 of the intelligent glasses 400. In terms of the above example, since the text content is “ . . . (omitted) some apples on the tree (omitted) . . . ”, the original content is “apple”, and the note associated with the original content is “edible fruit”, the displaying module 130 may determine that the text content includes the original content, and display the note “edible fruit” on the glass 420. It is to be particularly described that when the intelligent glasses 400 displaying the note “edible fruit” on the glass 420, the note “edible fruit” may be further projected onto the text content by the projection or the note is played by the TTS technology.

In view of the above, it may be known that the present invention has the difference as compared to the prior art that the text content is detected and a reading information comprising the original content and note is acquired. When the text content includes the original content, the associated note is directed to be displayed on the glasses of the intelligent glasses, whereby solving the issue that in the prior art and it brings convenience for organizing notes.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A note prompt method used for intelligent glasses, comprising:
acquiring at least a reading information by the intelligent glasses, the reading information comprises an original content and a note, the note being associated with the original content;
detecting a text content by the intelligent glasses;
detecting the original content in the text content; and
displaying the note on the intelligent glasses.

2. The note prompt method used for intelligent glasses as claimed in claim 1, wherein the intelligent glasses acquire at least the reading information by photographing or scanning.

3. The note prompt method used for intelligent glasses as claimed in claim 1, wherein the note is projected to the glass when the intelligent glasses displaying the note.

4. The note prompt method used for intelligent glasses as claimed in claim 1, wherein the step of acquiring the reading information is performed using a sound receiving element and generating the original content and the note by a speech-to-text (STT).

5. The note prompt method used for intelligent glasses as claimed in claim 4, further comprising a step of playing the node by a text-to-speech (TTS) convert the note into the sound when the node is displayed on the glass of the intelligent glasses.

6. A note prompt system used for intelligent glasses, comprising:
an acquiring module, acquiring at least a reading information, comprising an original content and a note, the note being associated with the original content;
a detecting module, detecting a text content; and
a displaying module, displaying the note on the glasses of the intelligent glasses when detecting the original content in the text content.

7. The note prompt system used for intelligent glasses as claimed in claim 6, wherein the intelligent glasses acquire at least a reading information by photographing or scanning.

8. The note prompt system used for intelligent glasses as claimed in claim 6, wherein the intelligent glasses project the note on the glass when the intelligent glasses displaying the note of the original content.

9. The note prompt system used for intelligent glasses as claimed in claim 6, wherein the reading information is acquired by a sound receiving element, and generating the original content and the note through a speech-to-text (STT).

10. The note prompt system used for intelligent glasses as claimed in claim 9, wherein the intelligent glasses further play the note by a text-to-speech (TTS) when the note is displayed on the glass of the intelligent glasses.
